(19) United States
(12) Patent Application Publication
(10) Pub. No.: US 2014/0145837 A1
(43) Pub. Date: May 29, 2014

(54) METHOD AND APPARATUS FOR PROVIDING REVERSE LIGHTS TO A TRAILER

(71) Applicants: Michael John DOUGLAS, Islip, NY (US); Gretchen Carol DOUGLAS, Islip, NY (US)

(72) Inventors: Michael John DOUGLAS, Islip, NY (US); Gretchen Carol DOUGLAS, Islip, NY (US)

(21) Appl. No.: 14/094,281

(22) Filed: Dec. 2, 2013

Related U.S. Application Data
(63) Continuation-in-part of application No. 13/105,180, filed on May 11, 2011.
(60) Provisional application No. 61/465,843, filed on Mar. 25, 2011.

(51) Int. Cl. B60Q 1/22

(52) U.S. Cl. CPC B60Q 1/22
USPC 340/431

(57) ABSTRACT

A wireless reverse light system for trailers is provided. A transmitter is configured to replace a light bulb or an entire light assembly of at least one reverse light already contained in the vehicle configured to pull the trailer. When the vehicle or tractor is put into reverse gear, the transmitter in place of the reverse light bulb or reverse light assembly sends a wireless trigger or activation signal to a receiver light that is has been attached to a rear and/or side of the trailer. When the wireless signal is received by the receiver, it triggers the connection of a battery supply to light and/or audible indicators contained therein, thereby providing a reverse light or lights at the rear/sides of the trailer where none exist.

### CROSS REFERENCE TO RELATED APPLICATIONS

This application is a continuation-in-part of co-pending U.S. patent application Ser. No. 13/105,180 filed on May 11, 2011, which claims priority from U.S. Provisional Patent Application Ser. No. 61/465,843 filed on Mar. 25, 2011, the entire contents of which is incorporated herein by reference.

### BACKGROUND

1. Technical Field

The present invention relates to trailers. More particularly, it relates to a method and apparatus for adding reverse lights to trailers which do not have the same.

2. Description of related art

Generally, tractors (trucks) are used to pull trailers of various sizes. These tractors include reverse lights and sometimes (but not always) include chimers to provide audible notice of the engagement of the reverse gear of the tractor. Unfortunately, the trailers that are connected to these tractors do not include reverse lights. As such, when the trailer is attached to the tractor, and the tractor engages reverse gear, it is next to impossible to see the reverse lights on the tractor (except from very limited angles from the sides of the trailers) as they are hidden underneath the trailer, which can be anywhere from 20-53 feet long. Thus, unless the tractor includes a chimer, there is no way for the persons or vehicles behind the trailer to know that the trailer has engaged the reverse gear and is backing up.

### SUMMARY

According to one aspect of the invention, the wireless reverse light assembly is for use with trailers connectable to tractors. The tractors have reverse light assemblies built therein. The wireless reverse light assembly includes a transmitter connectable to at least one reverse light assembly of the tractor, and a receiver connectable to a trailer and having at least one light contained therein. The receiver is configured to respond to a wireless trigger signal sent from the transmitter and activate the at least one light contained therein. The transmitter is configured to send the wireless trigger signal to the receiver when the tractor has engaged reverse gear.

According to another aspect of the invention, the wireless reverse light system for trailers includes a transmitter in signal communication with a tractor pulling the trailer and being configured to transmit a wireless trigger signal in response to engagement of a reverse gear of the tractor, and a receiver light assembly releasably connectable to the a rear or side of the trailer and configured to illuminate one or more lights contained therein in response to receipt of the wireless trigger signal.

According to another aspect of the invention, the method for providing wireless reverse lights to a trailer not having reverse lights starts with removing a reverse light bulb from an existing reverse light assembly on a vehicle pulling the trailer. The removed reverse light bulb or reverse light assembly is replaced with a wireless transmitter configured to transmit a wireless activation signal in response to activation of a reverse gear and thereby the reverse light assembly generated by the vehicle pulling the trailer. A wireless battery powered receiver light assembly is configured to be releasably attached to and selectively positioned on a rear end or side of the trailer. The wireless receiver light assembly detects the transmitted activation signals and in response connects the battery power to a light source contained therein when a reverse gear in the vehicle pulling the trailer has been engaged. The wireless light receiver maintains power to the light source at all times while during engagement of the reverse gear of the vehicle pulling the trailer.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1a shows an example of a tractor (truck) and trailer configuration to which the present invention is applicable;

FIGS. 1b-1e show lens shape examples of the transmitter portion of the wireless trailer reverse light system according to an embodiment of the invention;

FIGS. 2a-2c shows the transmitter portion of the wireless trailer reverse light system according to an embodiment of the invention;

FIGS. 3a-3d show exemplary shapes of the receiver portion of the wireless trailer reverse light system according to an embodiment of the invention;

FIGS. 4a-4b shows the receiver portion of the wireless trailer receiver light system according to an embodiment of the invention; and

FIG. 5 is a flow diagram of the method for providing reverse lights to trailers, according to an embodiment of the invention.

### DETAILED DESCRIPTION

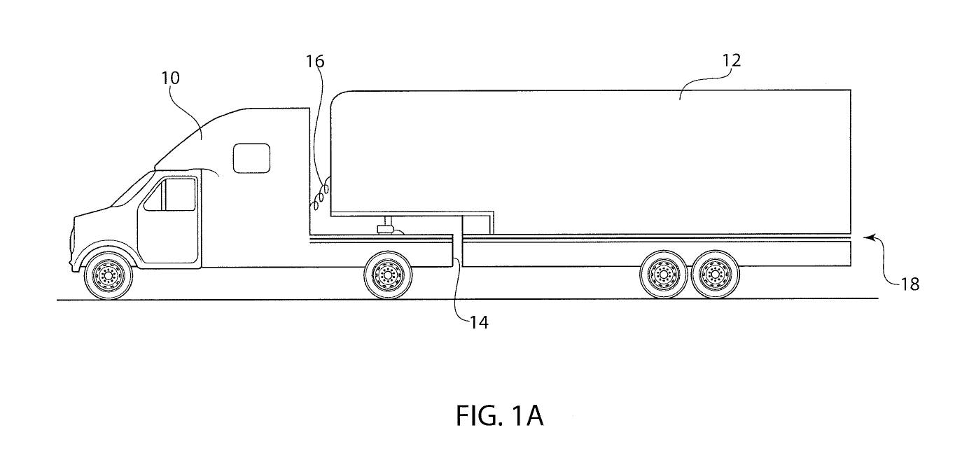

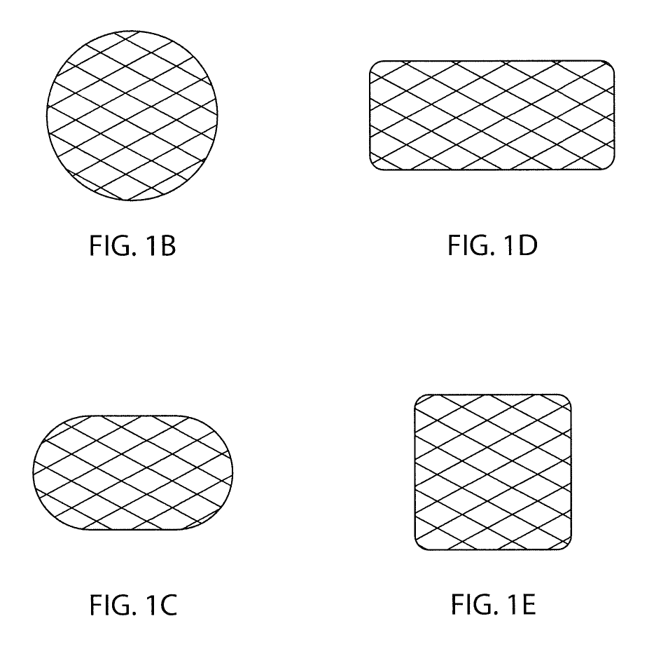

Referring to FIG. 1a, there is shown a tractor 10 and a trailer 12 connected thereto. The Tractor includes reverse lights 14 at the back of the trailer connection portion of the same. Although the size of the tractor 10 may vary, all tractors include brake and reverse lights at the rear of the same. The tractor is generally electrically connected to the trailer 12 via a connection line 16 which has specific connectors with mating characteristics. It is through this connection line that the trailer 12 receives electric power and is couples the brake and running lights of the trailer to the Tractor.

However, those of skill in the art will appreciate that most trailers 12 do not come equipped with reverse lights at the rear 18 thereof. As such, the electrical connection 16 does not operate to provide reverse light capability at the rear 18 of the trailer 12. The present invention solves this problem by providing wireless reverse lights that can be either permanently or releasably attached to the rear 18 and/or the sides of any trailer 12.

According to an embodiment of the invention, the wireless reverse lights for trailers includes a first transmitter part configured to replace an existing reverse light assembly on the tractor, and a second receiver/light part, wirelessly in communication with the transmitter part, connected to the rear 18 or sides of the trailer to provide illumination and/or audible chiming when the reverse gear of the tractor is engaged.

Since the shape of the existing reverse light assemblies may vary between tractor manufacturers, the present invention is intended to accommodate all various sizes and shapes of such existing reverse light assemblies. FIGS. 1b-1e show some examples of the different shape assemblies of the first part of the system. Those of skill in the art will appreciate that any other sizes may be implemented without departing from the scope of the present invention.

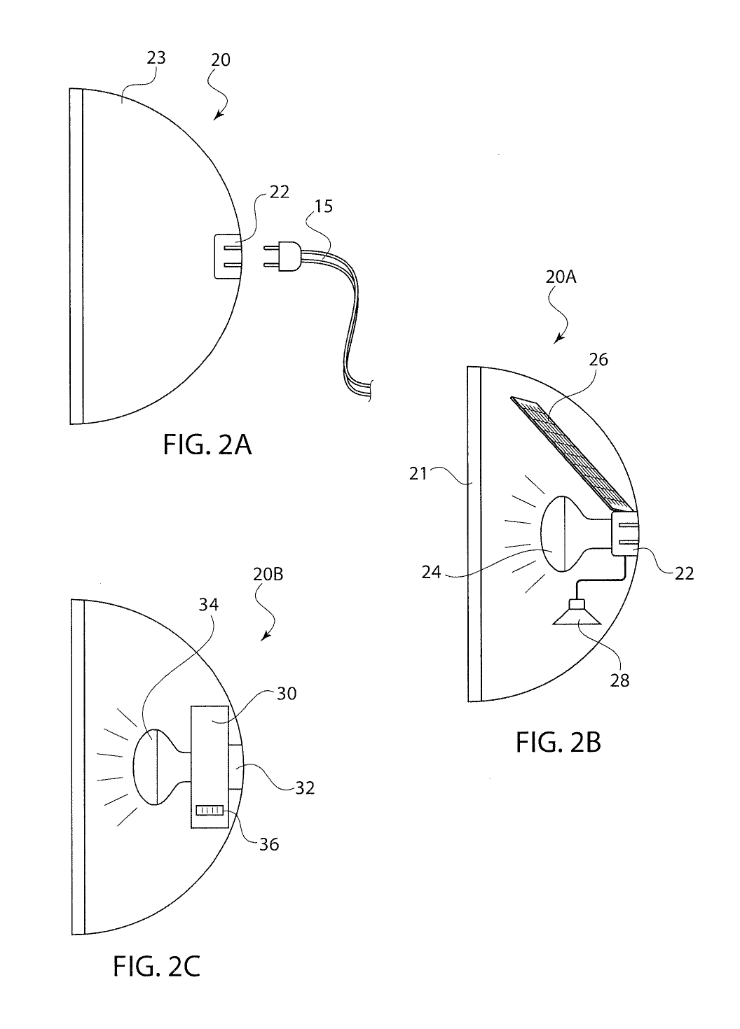

FIG. 2a shows an example of the transmitter part 20 according to an embodiment of the invention. Transmitter part 20 includes a housing 23 having connector 22 that is configured to mate with the existing reverse light assembly connector 15 contained within the existing reverse light assembly 14 of the tractor. Those of skill in the art will appreciate that the housing 23 can be shaped to replace the existing reverse light assembly of the tractor (not shown).

FIG. 2b shows a first embodiment of the internal workings of the transmitter part 20A according to the present invention. The transmitter part 20A includes a light bulb 24 and a motherboard or printed circuit board (PCB) 26 which are both electrically connected to the connector 22. The PCB 26 includes wireless transmitter capability and is configured to be activated when the power to the connector 22 is activated, as a result of the reverse gear of the tractor being engaged. Thus, when the reverse gear of the tractor is engaged, the light 24 will illuminate and the transmitter circuitry on PCB 26 will be activated to send a wireless trigger signal to the wireless light receiver or second part of the system.

In another implementation of the invention, the transmitter part 20A can also include a reverse chimer 28, which would also be activated in response to the engagement of the reverse gear and thus power to the connector 22.

FIG. 2c shows another implementation of the transmitter part 20B where the transmitter circuitry/PCB 30 is connected directly to the connector 22, and the light bulb 34 connects to the PCB 30. In this configuration, PCB 30 includes the transmitter circuitry, may include the chimer (depending on whether the tractor includes a chimer already), and the means to illuminate the light 34 when power to the connector 22 is activated. In this embodiment, it is contemplated that that PCB 30 includes a mating connector that would mate with the existing reverse light bulb socket 32 on the tractor reverse light assembly. In this embodiment, the need for a separate housing could be eliminated and the wireless trailer reverse light system of the present invention could be implemented by simply changing the reverse light bulb of the tractor with the PCB 30 which would receive the light bulb 34.

According to another embodiment of the invention, it is contemplated that the tractor manufacturers could include the transmitter circuitry into the tractor during manufacture of the same. In this implementation, the transmitter circuitry would be in signal communication with the tractor so as to detect the engagement of the reverse gear. Here, the tractor manufacturer could provide the wireless receiver lights corresponding to the pre-installed transmitters with each tractor sold.

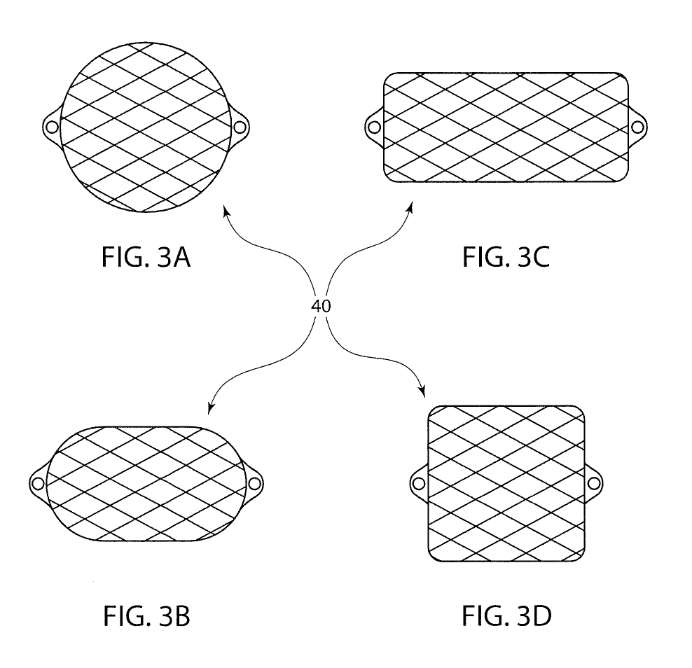

Referring generally to FIGS. 3a-3d, there is shown various shapes and sizes of the wireless light receiver 40 according to embodiments of the invention. These wireless receivers 40 can be permanently or releasably attached to rear of the trailer by any suitable means. Examples of such connections can be, screw fasteners, adhesives, magnets, hook and loop fasteners, and the like. Those of skill in the art will appreciate that various means for connecting the wireless light receiver to the read of the trailer can be implemented without departing from the scope of the present invention.

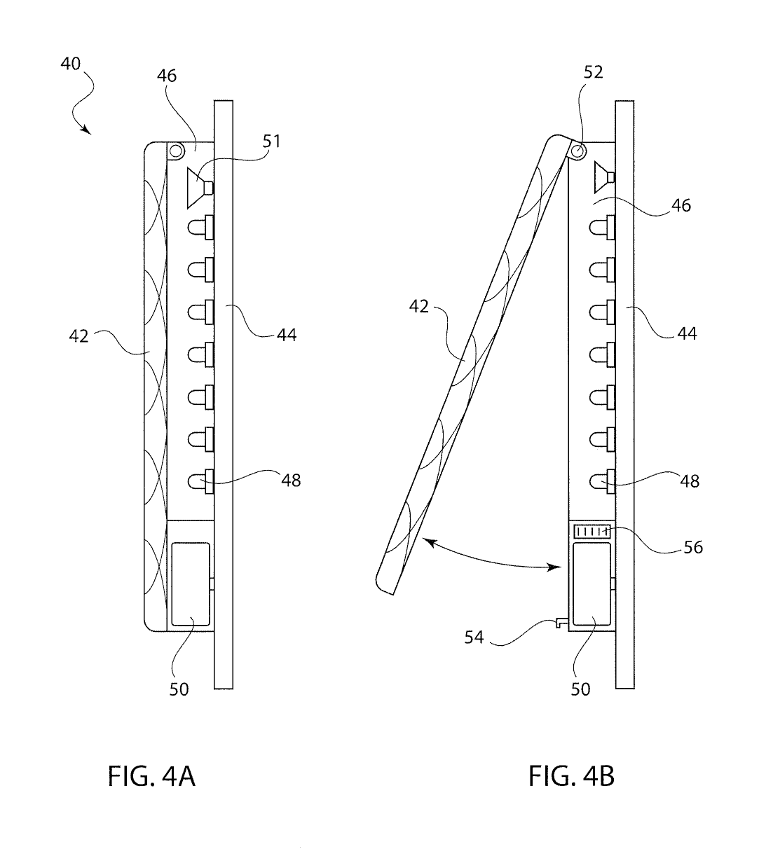

FIGS. 4a and 4b show an exemplary embodiment of the wireless light receiver 40 according to the invention. The wireless light receiver 40 includes a front lens portion 42 and a rear mounting or connecting portion 44. Receiver circuitry/PCB 46 contained within the receiver 40 includes a battery power supply 50 and one or more low voltage lights (e.g., super bright LEDs) 48. In other contemplated embodiments, the receiver PCB can also include a chimer 51.

As mentioned above, the connecting portion 44 can be implemented in many different ways. In one preferred implementation, the connecting portion 44 includes strong magnets that can be adhered to the trailer. The wireless light receivers 40 can be mounted on the rear of the trailer, and/or on the sides of the trailer so as to enable illumination of the sides of the trailer during reverse operations.

During operation, the receiver circuitry 46 responds to a wireless trigger signal received from the transmitter circuitry 26, 30 by connecting the power/battery 50 to the lights 48. When the receiver PCB 46 includes the chimer 51, the chimer is also activated upon receipt of the wireless trigger signal. In this manner, the lights 48 provide reverse lights to the trailer without requiring any re-wiring or alterations to either the tractor or the trailer. In addition, a chimer can be added at the rear of the trailer for tractors that do not have chimers, and possibly in addition to the tractor chimer. As described above, the wireless trigger signal is sent by the transmitter circuitry in response to the engagement of reverse gear of the tractor.

In the preferred implementation of the invention, the detection of the engagement of the reverse gear of the tractor transmission is performed using the existing reverse light assembly of the tractor. Those of skill it the art will appreciate that other methods of detecting the engagement of the reverse gear of the tractor could also be employed without departing from the spirit of the invention. Such methods may include, for example, communication with the tractor computer or electrical system, the gear shifter or transmission control systems, if any.

FIG. 4B shows an embodiment where the lens 42 of the receiver light assembly 40 is hinged 52 so as to allow access to the inside of the wireless light receiver 40 for purposes of changing the battery 50, cleaning, etc. Those of skill in the art will appreciate that any type of releasable connector 54 can be implemented for allowing the lens 42 to be opened and closed, preferably without allowing moister to penetrate the light assembly once closed.

Those of skill in the art will appreciate that the wireless communication protocol of the present invention can be, for example, radio frequency (RF) in any suitable range. It is further contemplated that the transmitter PCB 30 and corresponding receiver PCB 46 can be manufactured to operate at different frequencies so as to accommodate fleets of trucks and so as to prevent the accidental triggering of the wireless reverse light assemblies.

In one exemplary embodiment, the transmitter PCB 30 and corresponding receiver PCB 46 can include frequency changing means, for example, dip switches 36 (FIGS. 2c) and 56 (FIG. 4b) which allow the user/owner to change the frequency at which the systems operate. Although shown in the form of a mechanical dipswitch, it is further contemplated that the frequency changing capability can be implemented in other known ways without departing from the scope of the present invention. For example a spread spectrum RF signal could be used so as to prevent unauthorized identification of frequencies use to activate the wireless receivers. The switching of frequencies can also be made automatic according to a predetermined plan.

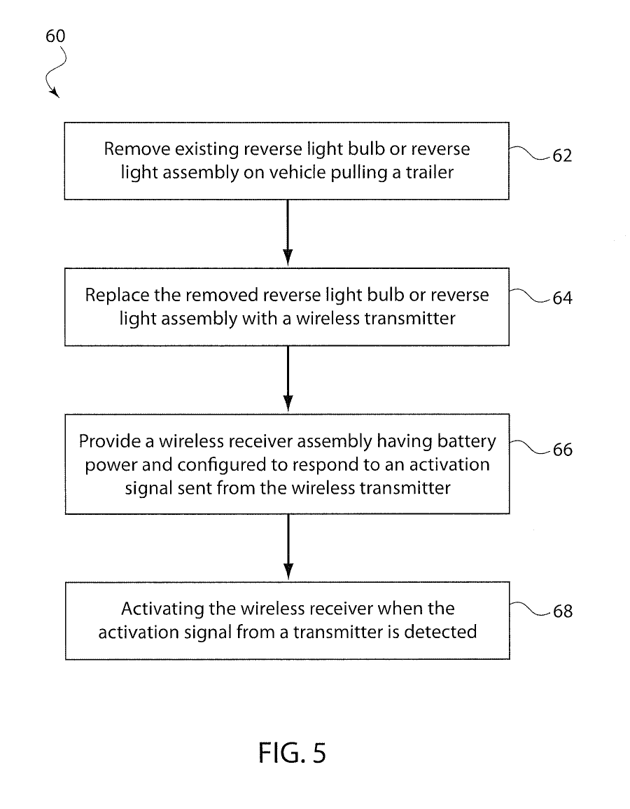

FIG. 5 shows the method 60 for providing a reverse light to a trailer that does not have one. Initially a reverse light bulb or the entire reverse light assembly of the vehicle pulling the trailer is removed (62). The removed light bulb or reverse light assembly is replaced with a wireless transmitter (64). A wireless receiver light assembly is provided (66) and has its own battery power. The wireless receiver light assembly is releasably attached to a side or rear of the trailer being pulled and is configured to respond to a received activation signal sent from the transmitter. Once the wireless receiver detects the activations signal transmitted from the wireless transmitter, the wireless receiver is activated (68) by connecting the battery source to the light source, thus providing illumination where the same was not previously available.

In one embodiment, the wireless transmitter transmits a signal on pulse activation signal which is not a constantly transmitted signal. The wireless receiver will detect the signal pulse activation signal and connect the battery source to the light to illuminate the same. In this embodiment, when the reverse gear of the pulling vehicle is disengaged (and the reverse light assembly deactivated, the transmitter will send a signal off pulse signal, which when received by the wireless receiver will cause the same to disconnect the battery from the light source and thereby turn off the light.

In another embodiment, the wireless transmitter transmits a continuous activation signal once the reverse gear (and thereby the reverse light) of vehicle pulling the trailer is activated. When the wireless receiver detects the continuous activation signal, it will connect the battery source to the light and illuminate the same. Once the transmitter discontinues transmitting the activation signal, the receiver will detect the lack of the presence of the same and deactivate the light by disconnecting the same from the battery source.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A method for providing wireless reverse lights to a trailer not having reverse lights, the method comprising the steps of:
removing a reverse light bulb from an existing reverse light assembly on a vehicle pulling the trailer;
replacing the removed reverse light bulb with a wireless transmitter operating on one or more a plurality of designated frequencies, said wireless transmitter having a light bulb socket therein for optionally receiving the removed reverse light bulb, said wireless transmitter transmitting a wireless activation signal on one or more of the plurality of designated frequencies in response to activation of a reverse gear and thereby the reverse light assembly generated by the vehicle pulling the trailer;
providing at least one wireless battery powered receiver light assembly configured to be releasably attached to and be selectively positioned on a rear end or side of the trailer, and
activating the wireless receiver light assembly by connecting the battery power to a light source contained therein when a reverse gear in the vehicle pulling the trailer has been engaged and the wireless activation signal has been transmitted by the transmitter and detected by the receiver; said wireless light receiver maintaining power to the light source at all times while during engagement of the reverse gear of the vehicle pulling the trailer.

2. The method of claim 1, further comprising switching of the one or more plurality of frequencies of the wireless transmitter and the wireless receiver.

3. A method for providing wireless reverse lights to a trailer not having reverse lights, the method comprising the steps of:
removing a reverse light assembly from an existing reverse light assembly on a vehicle pulling the trailer;
replacing the removed reverse light assembly with a wireless transmitter assembly having a wireless transmitter integrated therein, said wireless transmitter operating on one or more a plurality of designated frequencies and transmitting a wireless activation signal on one or more of the plurality of designated frequencies in response to activation of a reverse gear and thereby activation of the reverse light assembly generated by the vehicle pulling the trailer; and
providing at least one wireless battery powered receiver assembly configured to be releasably attached to and selectively positioned on a rear end or side of the trailer, said wireless receiver having at least one light for illuminating the rear end or side of the trailer in response to the activation of a reverse gear in the vehicle pulling the trailer, said at least one light being responsive to the wireless activation signal.
